(19) United States
(12) Patent Application Publication
(10) Pub. No.: US 2015/0306770 A1
(43) Pub. Date: Oct. 29, 2015

(54) DETACHABLE ROBOTIC ARM HAVING INTERFERENCE DETECTION SYSTEM

(71) Applicants: Nimish MITTAL, Overland Park, KS (US); Sergio GONZALEZ, Spring, TX (US); Matthew NOJOOMI, Granite Bay, CA (US)

(72) Inventors: Nimish MITTAL, Overland Park, KS (US); Sergio GONZALEZ, Spring, TX (US); Matthew NOJOOMI, Granite Bay, CA (US)

(21) Appl. No.: 14/695,979

(22) Filed: Apr. 24, 2015

Related U.S. Application Data
(60) Provisional application No. 61/984,435, filed on Apr. 25, 2014.
(60) Provisional application No. 61/984,468, filed on Apr. 25, 2014.

(51) Int. Cl. B25J 9/16; B25J 19/02

(52) U.S. Cl. CPC B25J 9/1676; B25J 19/027

(57) ABSTRACT

Robotic arm system having a robotic arm system configured to detachably couple to a structure. The robotic arm system can have a base, an arm assembly, at least one power source and a manipulator. The arm can include a lower arm and an upper arm. The lower arm can be rotatably coupled to the base at a first end end and rotatably coupled to the upper arm at an opposing end. The upper arm can be coupled to the manipulator at an end opposite to the lower arm. The base can include at least one electric motor configured to rotate the lower arm in relation to the base. The lower arm can be coupled to at least one electric motor configured to rotate the upper arm in relation to the lower arm. The manipulator can include at least one electric motor configured to actuate the manipulator.

### CROSS-REFERENCE TO RELATED APPLICATIONS

This application claims priority to U.S. Provisional Application No. 61/984,435, filed Apr. 25, 2014, and U.S. Provisional Application No. 61/984,468, filed Apr. 25, 2014, the contents of which are entirely incorporated by reference herein.

### FIELD

The present disclosure relates generally to robotic arms, and more specifically, to detachably coupled robotic arms having an interference detection system.

### BACKGROUND

Robotic arms can be used to perform a number of complex tasks and improve human life. Robotics can allow humans to perform functions not otherwise possible. They can extend reach, improve strength, increase speed and increase endurance.

### BRIEF DESCRIPTION OF THE DRAWINGS

In order to describe a manner in which features of the disclosure can be obtained, reference is made to specific embodiments that are illustrated in the appended drawings. The components in the drawings are not necessarily drawn to scale, the emphasis instead being placed upon clearly illustrating the principles of the disclosure. Based on an understanding that these drawings depict only example embodiments of the disclosure and are not intended to be limiting of scope, the principles herein are described and explained with additional specificity and detail through the use of the accompanying drawings. Moreover, in the drawings, like reference numerals designate corresponding parts throughout the several views.

FIG. 1 is an isometric view of an example embodiment of a detachable robotic arm system.

FIG. 2 is a planar view of an example embodiment of a base.

FIG. 3 is a planar view of an example embodiment of an arm.

FIG. 4 is an isometric view of an example embodiment of a manipulator.

FIG. 5 is a planar view of an example embodiment of a detachable robotic arm assembly.

FIG. 6 is a planar view of an example embodiment of a detachable robotic arm.

FIG. 7 is an isometric view of an example embodiment of a detachable robotic arm assembly.

FIG. 8 is an elevational top view of an example embodiment of a detachable robotic arm assembly.

FIG. 9 is a flow chart for an example embodiment of an interference detection system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicate that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “wheelchair” is defined as any device that is used to assist the mobility of one or more persons. The term “wheelchair” as used in this disclosure is not limited to mobility with wheels, but includes the use of wheels, treads, rollers, or the link.

A robotic arm assembly configured to detachably couple to a structure is disclosed herein. In at least one embodiment, the robotic arm assembly can be configured to detachably couple to a wheelchair. In other embodiments, the robotic arm assembly can be coupled to any number of stationary and moving structures including, but not limited to wheelchairs, ceilings, hospital beds, tables, portable stands, walls, or any other mounting surfaces. In at least one embodiment, the robotic arm assembly can be configured to detachably couple to a wheelchair for users with limited mobility, range of motion, or strength. The robotic arm can have a base, an arm, and a manipulator. The arm can include a lower arm and an upper arm. The robotic arm assembly can have an interference detection system configured to prevent collisions with objects that might object movement of the robotic arm. In at least one embodiment, the manipulator can include at least one prong or end effector.

The robotic arm assembly can be electrically coupled to a control system configured to control the movement of the robotic arm. The control system can include one or more controllers configured to accept user inputs and move the robotic arm accordingly. The control system can be configured to control the rotation of the lower arm, the rotation of the upper arm, the actuation of the manipulator, the rotation of the manipulator, and any other movement or actuation of the robotic arm assembly. The control system can also turn the robotic arm assembly on/off. In at least one embodiment, the controller is a video game controller coupled to the robotic arm assembly by BLUETOOTH®.

The control system can include physical and non-physical controllers. Physical controllers can include a joy stick, directional pad, a 3-D mouse, or one or more buttons. Non-physical controllers can include eye tracking or voice command. The control system can have one or more controllers, either physical, non-physical, or a combination thereof, implemented simultaneously. In at least one embodiment, the control system can have a joystick and D-pad implemented within a single housing. In other embodiments, the control system can have separate individual controllers such as a joystick and eye tracking.

The wheelchair can be motorized, containing its own power source, or can be non-motorized. The robotic arm assembly can be detachably coupled to the wheelchair. The base can detachably couple to the wheelchair through the use of any suitable removable detachment mechanism, for example cotter pins, nuts and bolts, threadable engagement, or hook/clamp arrangement. In at least one embodiment, the robotic arm can be coupled and un-coupled without the use of tools. The upper arm and lower arm can be detachably coupled to base through a similar attachment mechanism.

The detachably coupling between the robotic arm assembly and the wheelchair can include mechanical and electrical coupling. The detachable electrical coupling can include quick connectors such as male-female pin arrangements, electrical contacts, or other suitable electrical coupling. The detachably coupling is configured to be removed without the use of tools. In at least one embodiment, the detachably coupling includes mechanical, electrical, and optical coupling.

The robotic arm can be made from any suitable material, for example aluminum, carbon fiber, resins, composites, and high strength plastic. The base can include a power source and can further include at least one electric motor coupled to the power source. The power source can be electrically coupled to the wheelchair, or can be electrically independent from any wheelchair power source. In at least one embodiment, the power source can be a battery. The robotic arm assembly can have a charging port for recharging the battery. The battery can also be user replaceable allowing a user to use a charged battery for immediate use or recharge the battery for future use.

In at least one embodiment, the at least one electric motor can be a DC brushed motor with a built in planetary gearbox. In other embodiments, the at least one motor can be 12v DC planetary motor. In yet other embodiments, the robotic arm assembly can have more than one motor, each motor having different specification such as one 12v DC planetary motor, one 6v DC spur head motor, or any combination thereof.

The at least one motor can be can be located anywhere within the robotic arm assembly. In at least one embodiment, the at least one motor can be in base, the lower arm, the upper arm, or any combination thereof. In at least one example embodiment, the power source can include a quick disconnect coupling between the power source and the robotic arm.

The robotic arm assembly can include an emergency shut-off switch coupled to the power source to remove all power to the robotic arm. The emergency shut-off switch can be easily accessible and quickly operated to disrupt power. The emergency shut-off switch can be located so as to prevent incidental operation, but still easily accessible when needed. In at least one embodiment, the emergency shut-off switch can have a moveable cover to prevent accidental operation. In other embodiments, the emergency shut-off switch can be a push button level located near the motor or the power source.

The lower arm can be detachably coupled to the base and configured to rotate about a horizontal axis. The lower arm can further be configured to rotate about a vertical axis. In at least one embodiment, the lower arm can be configured to rotate about both a vertical and horizontal axis. Rotation about the vertical axis can allow the lower arm to spin relative to the base, thereby adjusting the direction in which arm extends in a horizontal plane. Rotation about the horizontal axis can allow the lower arm to move relative to a vertical plane, thereby adjusting the height at which the arm extends.

The at least one electric motor on the base can be configured to rotate the lower arm about the horizontal axis, vertical axis, or both. In another example embodiment, the robotic arm can include one electric motor configured to control the horizontal rotation, and another motor configured to control the vertical rotation. In one example embodiment the controller can be configured to rotate the lower arm (horizontally and/or vertically) based on user inputs.

The lower arm can further include at least one electric motor coupled to a power source and configured to rotate the upper arm. The upper arm can be configured to rotate about the horizontal axis and relative to the lower arm. In at least one embodiment, when the upper arm is fully extended, it forms a substantially linear line with the lower arm. In at least one embodiment, when the upper arm is fully retracted, it can be substantially parallel with the lower arm. In at least one embodiment, a user can control via the controller the rotation of the upper arm relative to the lower arm causing the upper arm to be substantially parallel or substantially linear to the lower arm or any position in between depending on need.

The upper arm can be detachably coupled to the manipulator. In at least one embodiment, the manipulator can be coupled to at least one electric motor coupled to the power source. In other embodiments, the manipulator can be driven by vacuum pressure, air pressure, or electric solenoids. The manipulator can include at least one prong or end effector configured to actuate. In at least one embodiment, the manipulator can include a plurality of prongs. In other embodiments, the at least one prong or end effector can be a single sticky surface. The prongs can each further include an inner gripping surface arranged to enable each inner gripping surface to face toward the other prongs inner gripping surface. The closed position can be defined by the plurality of prongs being positioned such that the inner gripping surfaces are substantially touching, while the open position can be defined as the plurality of prongs being positioned opposite the closed position. The plurality of prongs can be coated in a slip resistant material. In at least one embodiment, the slip resistant material can be a rubber with a relatively high friction co-efficient. In at least one other embodiment, the grippers can include replaceable slip resistant pads, rubber teeth, bumpers, or any other suitable gripping arrangement. In at least one embodiment, the inner surface can be grooved. The manipulator can be made from any suitable material, for example ABS plastic, high strength plastics, aluminum, carbon fiber, resins, and composites. In at least one embodiment the manipulator can be rotatably coupled to the upper arm allowing the manipulator to rotate about a longitudinal axis of the upper arm. In at least one embodiment the manipulator can be rotatably coupled to the upper arm allowing the manipulator to rotate about a perpendicular axis of the upper arm. In at least one embodiment, a user can actuate the at least one prong via the controller. In other embodiments, the manipulator can have three prongs and the user can actuate each prong individually using the controller.

The robotic arm can further include an interference detection system configured to cease movement of the robotic arm when an interference is detected. Interference can be any object located in such a way as to obstruct movement of the robotic arm. The interference detection system can be configured to prevent movement of the robotic arm assembly when triggered. The interference detection system can include at least one detection point configured to detect objects proximal to the robotic arm assembly. In at least one embodiment, the interference detection system can also include a microcontroller. The microcontroller can be coupled to the interference detection system and the power source. In at least one embodiment, the microcontroller can be a pre-manufactured chip.

In at least one embodiment, the interference detection system can include a plurality of detection points. The interference detection system can be configured to send a signal to the microcontroller when a detection point detects an impediment. Detection of an impediment can include the sensing of a resistive force which is greater than a predetermined threshold, for example. The microcontroller can be configured to remove power to any number or combination of the electric motors. The interference detection system can be configured to cease movement when the system detects a person or object impeding the path of motion of the device. In at least one embodiment, the detection system can determine the proximity of a nearby object and prevent collisions by halting movement. Once detected, the interference detection system can notify the device and shut down any number or combination of operating activities until the impedance status has changed. In at least one embodiment, when the interference detection system detects an impediment, the microcontroller will disregard control inputs made via the controller and the robotic arm will maintain its current state. In at least one other embodiment, when the interference detection system detects an impediment, the robotic arm assembly will retract from the impedance. In at least one other embodiment, when the interference detection system detects an impediment the microcontroller will disregard control inputs made via the controller except those in a direction away from the impediment.

In at least one embodiment, the interference detection system can be a capacitance based system capable of detecting change in capacitance of the sensor. The capacitance will vary based on objects that come within the proximity of the sensor. The sensor can be configured to determine the proximity of an object as the capacitance changes and halt movement of the robotic arm assembly. The sensor can include a conductive coating on certain areas of the robotic arm assembly. The robotic arm assembly can have conductive coatings on areas most prone to impedance such as the arm and manipulator. In at least one embodiment, the conductive coating can be on the entire robotic arm assembly.

The conductive coating can be wired to a hardware system of the sensor and act like a capacitive plate to detect interferences. The hardware system can have a microprocessor configured to determine the detected level of capacitance in relation to the threshold level of capacitance. The threshold level of capacitance can be calculated based on the arrangement of the conductive coating and orientation of sensors. The capacitance based system can uniquely distinguish between a human impedance and an inanimate object. The capacitance based system can determine whether an object has a high dielectric constant to make a determination between an impedance and an inanimate object. In at least one embodiment, the hardware system and the controller utilize a shared microprocessor to detect impedances and actuate the robotic arm assembly. In other embodiments, the hardware system utilizes an independent microprocessor. In yet other embodiments, the hardware system can use one or more logic gates to control the interference detection system.

In at least one embodiment, the interference detection system can be a mechanical switch lining the sides of upper and lower arms to detect interfering motion. In this embodiment, if the arm came in contact with an object, the mechanical switches can be depressed and signal a microcontroller to halt movement of the device. The mechanical switch can be a tape switch, in which two lengths of parallel copper plates are separated by a small distance. As an object comes in contact with the switch, the distance between the plates decreases, eventually causing them to contact each other and provide sensor feedback.

In another example embodiment of the interference system, the interference detection system can be an optical beam system. In this embodiment, a source of a beam, for example Infrared (IR), laser, or suitable optical beam, can be placed on any surface of the robotic arm assembly along with a network of optical lenses/mirrors channeling the beam to cover the surface area of the assembly. The lenses can be placed at the distal ends of each the upper arm and lower arm in order to direct the optical beam toward the opposite distal end. The arms can include a plurality of lenses directing the beam in a zig-zag pattern across the entire surface of the upper and lower arms, respectively. In this example embodiment, one distal end will have an optical beam source and the opposing distal end will have an optical beam receiver where the beam terminates. The receiver can continuously read a level of transmittance and determine if an object impedes the pathway of the optical beam. When the receiver determines that the level of transmittance falls outside a defined range, the microcontroller can halt motion of the robotic arm and can disregard inputs from the controller.

In another example embodiment of the interference system, the interference system can be a linear pin system. In this embodiment, an exterior panel of robotic arm can contain a plurality of smooth pins, each smooth pin can be inserted into a corresponding hole in the exterior panel of the robotic arm. This system can include springs inserted between the panels and the detection surface used to return the panel to its original position. As a force is applied to the panel, the panel depresses, therefore compressing the springs and proving constant feedback to a microcontroller. The junction between the panel and the arm can contain a sensor that will detect the displacement of the exterior panel, and thus detect any motion caused by the interference of a body.

Other example embodiments of the interference system include, but are not limited to, a detector for detecting changes in the electrical resistance of a material lining the exterior of the device, vision recognition through camera monitoring, IR detection, pressure sensor feedback, magnetic field changes or radar.

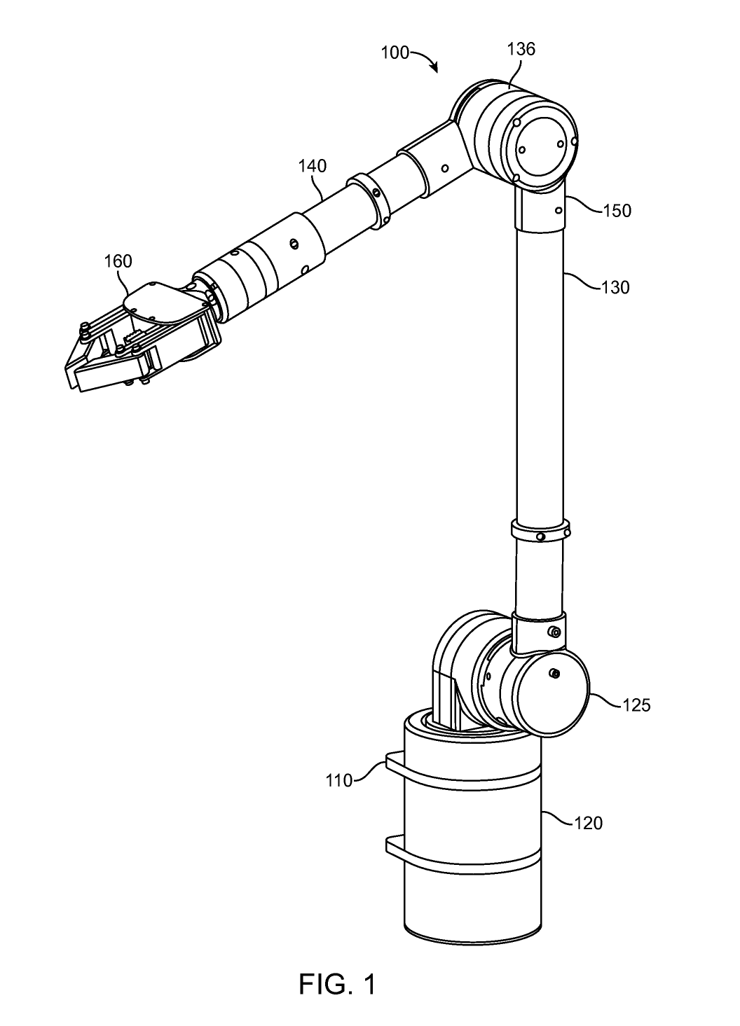

FIG. 1 illustrates an example embodiment of the robotic arm assembly 100 configured to detachably mount to a wheelchair (not shown). The robotic arm 100 can include the base 120, arm assembly 150, and manipulator 160. The arm assembly 150 can be rotatably coupled at a lower joint 125. Lower joint 125 can also be a detachable coupling between the arm assembly 150 and the base 120. The arm assembly 150 can be uncoupled from base 120 at lower joint 125 for storage and transportation. The base 120 can detachably couple to the wheelchair (not shown) via a mounting block 110. The mounting block 110 can be permanently coupled to the wheelchair (not shown). The base 120 can decouple from the mounting block 110 for storage and transportation. Arm assembly 150 can further include a lower arm 130 and an upper arm 140. The upper arm 140 and lower arm 130 can be rotatably coupled at upper joint 136. Upper arm 140 can rotate from being substantially parallel to lower arm 130 to being substantially linear with lower arm 130. The robotic arm assembly 100 can be configured to be coupled to a controller (not shown) and receive signals from the controller indicating specific actuation of the robotic arm assembly 100. A user can control the actuations of the robotic arm assembly 100 using the controller. In at least one embodiment, the controller can be a commercial off the shelf (COTS) controller such as a video game controller.

An interference detection system can be disposed on the robot arm 150 and manipulator to prevent collisions of the arm with users or adjacent people or animals. The interference detection system can be a capacitance based system capable of detecting change in capacitance of the sensor 200 as the arm 150 actuates within an environment. The capacitance will vary based on objects that come within the proximity of the sensor 200. The sensor 200 can be configured to determine the proximity of an object as the capacitance changes and halt movement of the robotic arm assembly. The sensor 200 can include a conductive coating on certain areas of the robotic arm assembly 100. The robotic arm assembly 100 can have conductive coatings on areas most prone to impedance such as the arm and manipulator. In at least one embodiment, the conductive coating can be on the entire robotic arm assembly 100.

The conductive coating can be wired to a hardware system of the sensor 200 and act like a capacitive plate to detect interferences. The hardware system can have a microprocessor configured to determine the detected level of capacitance in relation to the threshold level of capacitance. The threshold level of capacitance can be calculated based on the arrangement of the conductive coating and orientation of sensors. The capacitance based system can uniquely distinguish between a human impedance and an inanimate object. The capacitance based system can determine whether an object has a high dielectric constant to make a determination between an impedance and an inanimate object.

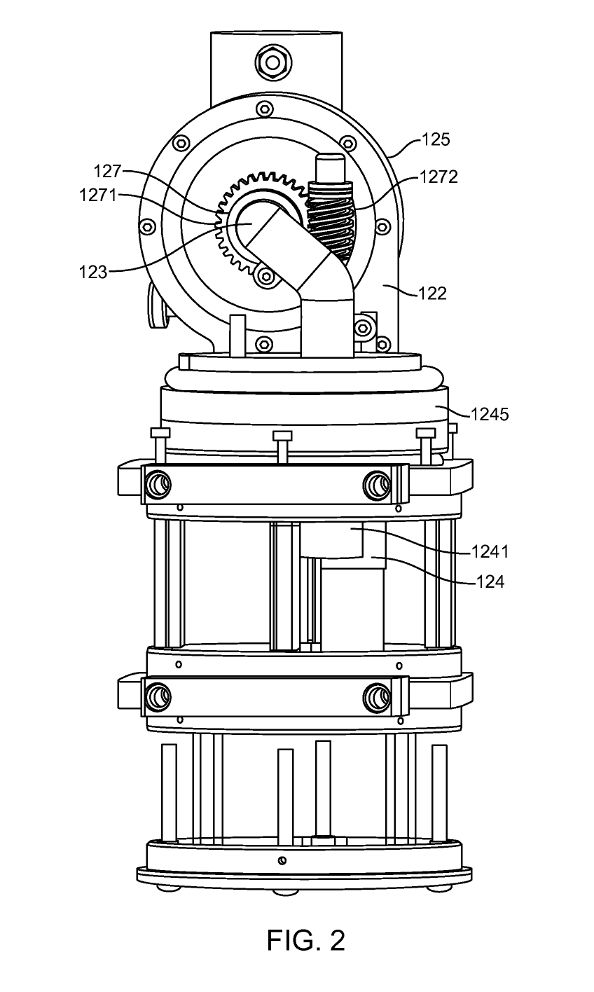

FIG. 2 illustrates a planar view of an example base 120. The base 120 can include a base casing 122, which can be configured to form housing for a compound ratio gearbox 127. The compound ratio gear box can include a base worm gear 1271 and base worm drive 1272. A 12 volt DC planetary motor 124 can be mounted in the base and power an input shaft of the gearbox 127. The motor 124 can be coupled to the base worm drive 1272 using a drive shaft. The base worm gear 1271 of the gearbox 127 can be concentric with a main shaft 123 configured to rotate the lower joint when power is applied. The main shaft 123 can be supported by bushings 126, for example oil impregnated bronze, that can be press fit into the base casing 122. The gearbox 127 can have a ratio of about 1:10 generation rotation at the lower joint of approximately 20 degrees per second. The base 120 can a turret motor 1241 configured to rotate the robotic arm 150 about a vertical axis. The turrent motor 1241 can include a clutch assembly 1245 to engage and actuate the robotic arm 150.

The base 120 can be configured to receive at least one power source 128. The at least one power source 128 can be a power supply or battery. As can be appreciated in FIG. 2, the at least one power source 128 can be a battery. The battery can be rechargeable through a charging port (not shown). The battery can also be configured to user-replacement to allow batteries to be swapped when actuation is necessary, and charging is unavailable. In the illustrated embodiment, the power source 128 is a re-chargeable Li-Ion battery.

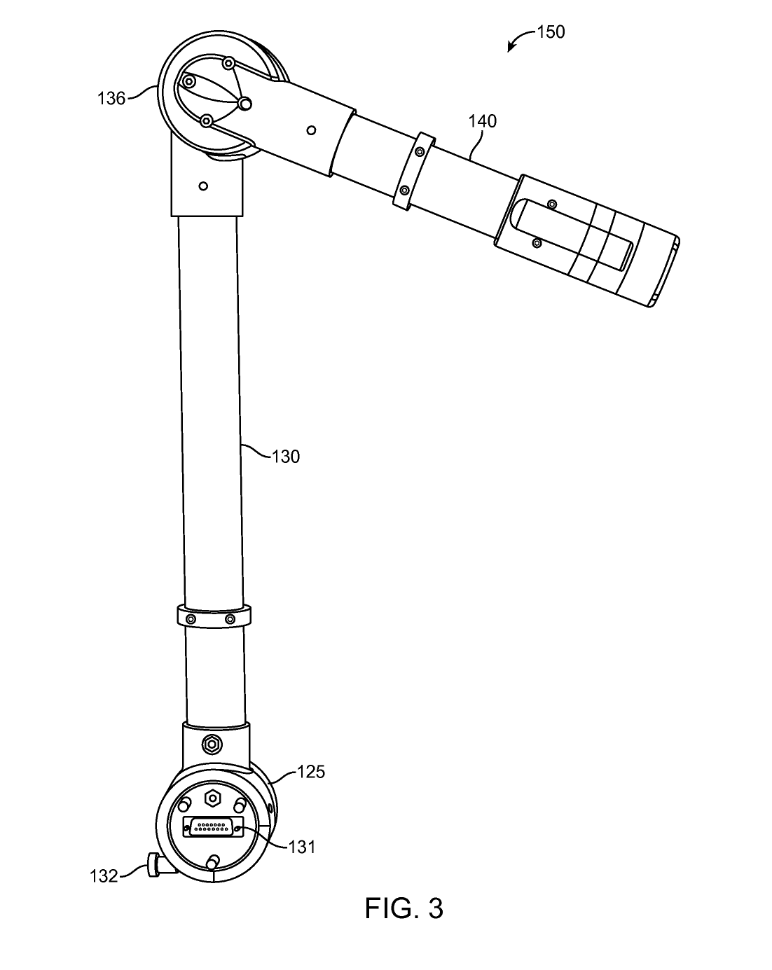

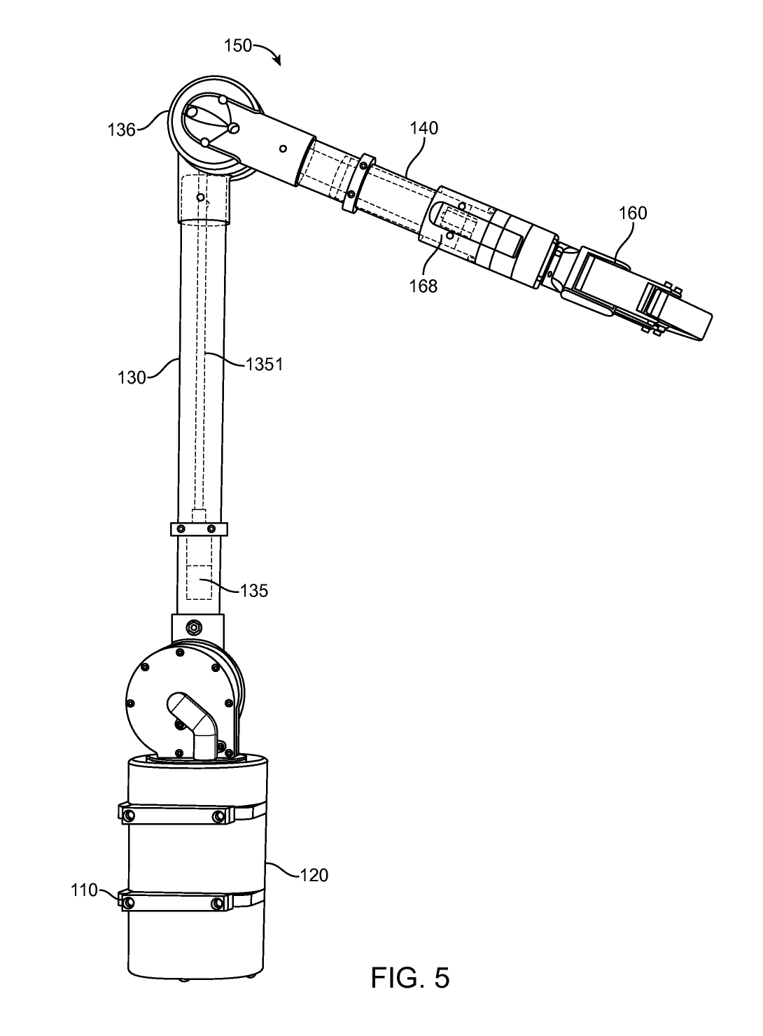

FIG. 3 illustrates a planar view of an example arm assembly 150. The lower arm 130 can include a lower joint 125 for detachably coupling with the base. The lower arm 130 can actuate independent of the base. The lower arm 130 can include an electric motor 135 configured to rotate the upper arm at the upper joint 136, and a compound gearbox 134. See FIG. 5. The overall ratio of the compound gear box 134 can be about 1:6 reduction configured to achieve an output rotation of about 25 degrees per second. The upper arm 140 and lower arm 130 can be made of square tube aluminum, or any other suitable material including but not limited to steel, plastic, and carbon fiber.

The lower joint 125 can have an emergency shut-off switch (not shown). The emergency shut-off switch can be configured halt all actuation and manipulation of the robotic arm assembly. The emergency shut-off switch can be conveniently located for easy accessibility in the event of an emergency. The emergency shut-off switch can be push-pull arrangement such that when in a first position complete control and actuation of the robotic arm assembly 100 is available. In a second position, no control or actuation of the robotic arm assembly 100 is available.

As can be appreciated in FIG. 3, the lower joint can have a quick release pin 132 configured detach the robotic arm 150 from the base 120 (shown in FIG. 1). The quick release pin 132 can decouple the robotic arm 150 and the base 120 from one another without the use of tools. The quick release pin 132 such that when in a first position, either pushed or pulled, the robotic arm 150 is coupled to the base 120 (shown in FIG. 1). In a second position opposite the first position, the robotic arm 150 is decoupled from the base 120 (shown in FIG. 1). As can further be appreciated in FIG. 3, the robotic arm 150 can include a communication port 131 configured to electronically couple the robotic arm 150 with the base 120 (shown in FIG. 1). In at least one embodiment, the communication port 131 is a Db15 connection. In other embodiments, the communication port 131 can be any coupling capable of communicatively coupling the robotic arm 150 and the base 120.

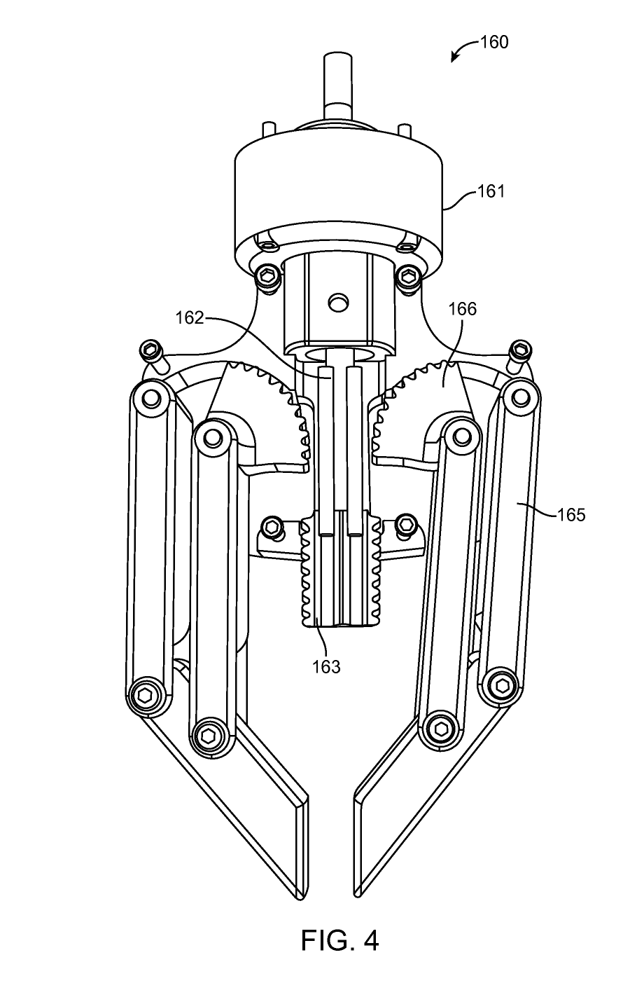

FIG. 4 illustrates an example embodiment of a manipulator assembly. The manipulator 160 can be a four-bar linkage system including two motors 161. In at least one embodiment, one motor can be configured to spin the manipulator 160 about a longitudinal axis of the upper arm 140 (shown in FIG. 3) and one motor 161 can be configured to actuate the manipulator 160. In other embodiments, the motors 161 can be configured to actuate individual prongs 165 of the manipulator 160.

The manipulator 160 can be laser cut from ABS plastic, or made from any other suitable material including, but not limited to, aluminum, steel, and carbon fiber. The manipulator 160 can have a plurality of prongs 165 configured to open and close via the motors 161. The manipulator 160 can be considered in a closed position when the plurality of prongs 165 are substantially touching and can be considered open when the plurality of prongs are not touching. As can be appreciated in FIG. 4, the manipulator 160 is in a partially open position. The plurality of prongs 165 can be coated in a slip resistant material capable of increasing the co-efficient of friction and thus increasing the grip strength of the manipulators 160.

As can be appreciated in FIG. 4, the manipulator 160 can have an actuator 162 configured to operate the prongs 165. The actuator 162 can have a pinion gear arrangement 163 configured to interact with a corresponding pinion drive linkage 166 of the prongs 165. As the motor 161 moves the actuator and the gear arrangement 163 interacts with the pinion drive linkage 166, the prongs can operate between the open position and closed position.

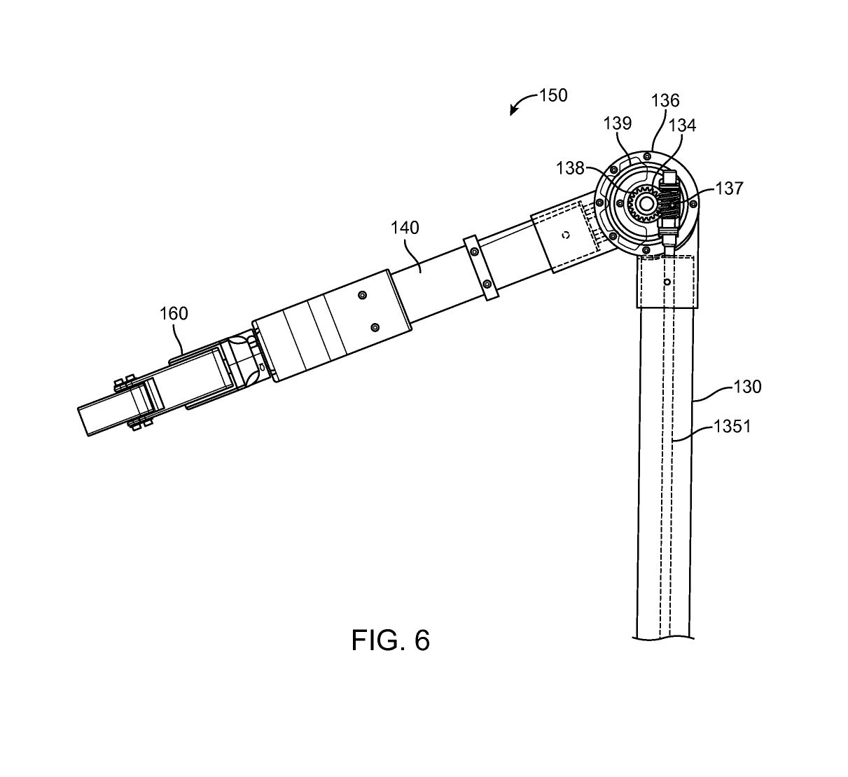

FIGS. 5-6 illustrate planar views of an example arm assembly 150. The arm assembly 150 can include at least one motor 135 positioned to actuate the upper joint 136. The motor 135 can be coupled to a compound gearbox 134 by a drive shaft 1351. In other embodiments, the upper joint 136 can have an electric motor. As can be appreciated in FIG. 5, the compound gearbox 134 can include a worm drive 137 and worm gear 138. The compound gearbox 134 can also include a clutch assembly 139 to engage and disengage the upper arm 140 as necessary to actuate with power from the motor 135 based on commands from the controller. The worm gear 138 can have a fixed position relative to the upper arm 140 and the worm drive 137 can engage with the worm gear 138 such that as the worm drive 137 rotates the worm gear 138 rotates causing the upper arm 140 to actuate. As can further be appreciated in FIG. 5, a drive shaft 1351 can be disposed within the lower arm 130. In at least one embodiment, the drive shaft 1351 can couple the upper joint 136 with a motor 135 positioned elsewhere in the robotic arm assembly 100. In other embodiments, the drive shaft 1351 can be configured to house electrical cabling for at least one motor 135 positioned at the upper joint.

As can be appreciated in FIG. 6, the base 120 can have the mounting block 110 disposed on thereon. The mounting block 110 can be configured to tool-less coupling and de-coupling of the robotic arm assembly 100 with a wheelchair (not shown). The arm assembly 150 can have the lower arm 130 coupled to the base 120 at the lower joint 125. The upper arm 140 and lower arm can be coupled at the upper joint 136. The upper arm 140 can have the manipulator disposed at the end opposite the attachment to the upper joint.

As can further be appreciated in FIG. 6, the manipulator 160 can have linear drive components 166 disposed within the upper arm 140. The linear drive components 168 can include additional motors to actuate the wrist, individual prongs, or provide additional gripping power depending on application.

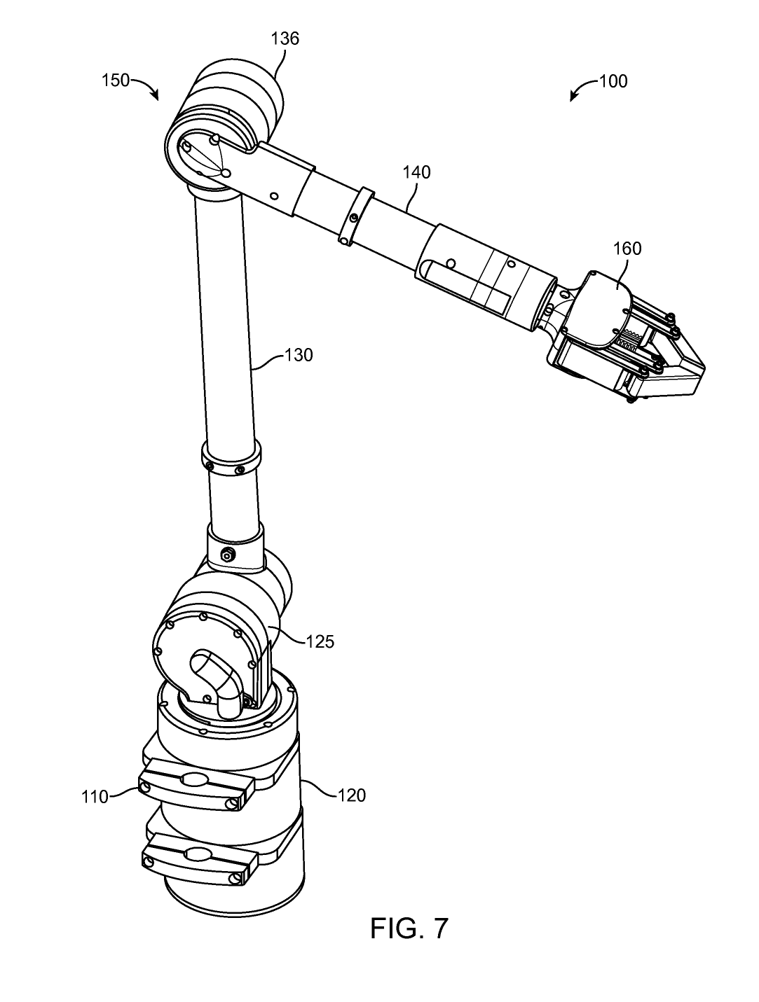

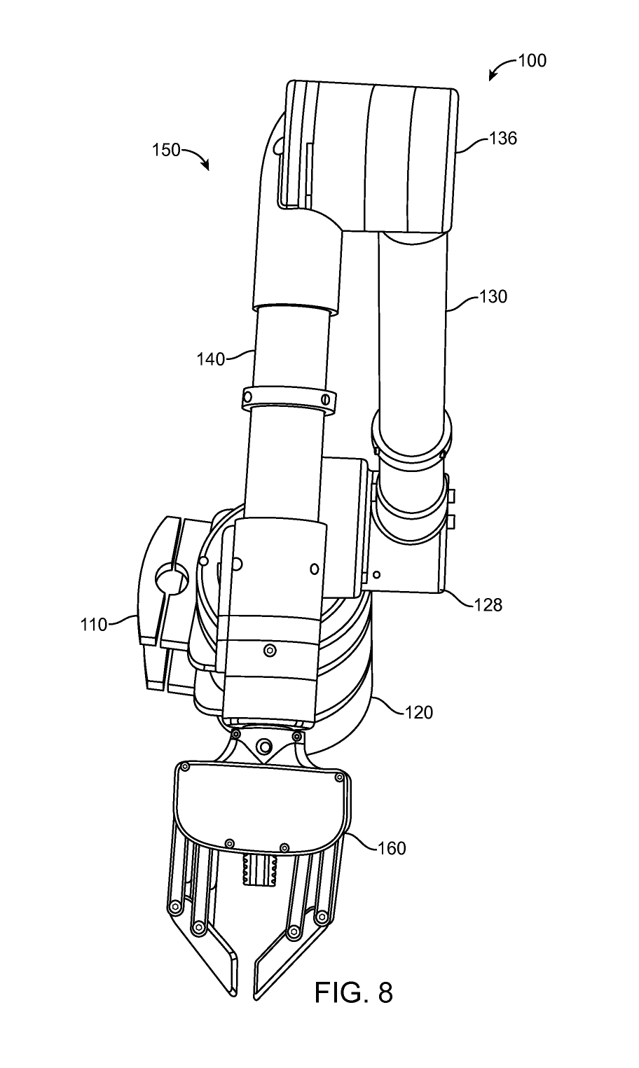

FIG. 7 illustrates an isometric view of an example robotic arm assembly 100. FIG. 8 illustrates an elevational top view of an example robotic arm assembly 100. As can be appreciated in FIGS. 7 and 8, the robotic arm assembly 100 can be detachably coupled at the base 120 by mounting block 110. The base 120 can be coupled to the robotic arm 150 at lower joint 125. Lower joint 125 can allow the lower arm 130 to actuate raising and lowering the arm 150 and rotating the arm about a longitudinal axis of the base 120. The manipulator 160 can be disposed at the end of the upper arm 140 and configured to operate an end effector. The end effector allowing the robotic arm to interact with the surrounding environment.

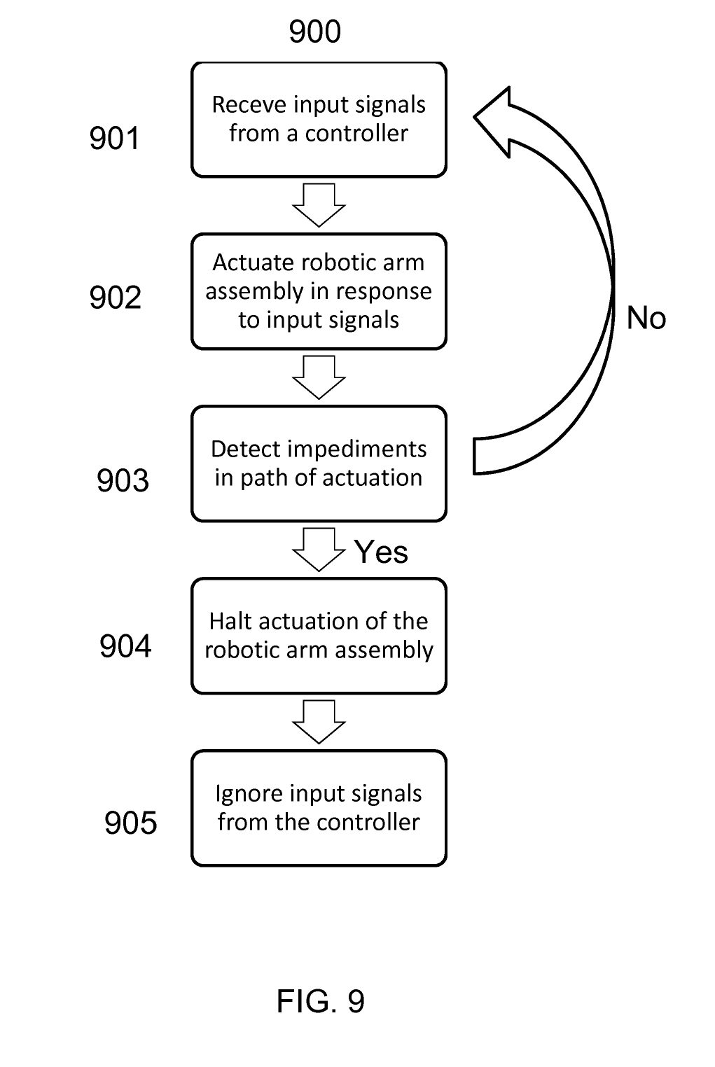

Referring to FIG. 9, a flowchart is presented in accordance with an example embodiment. The example method 900 is provided by way of example, as there are a variety of ways to carry out the method. The method 900 described below can be carried out using the configurations illustrated in FIGS. 1-8, for example, and various elements of these figures are referenced in explaining example method 900. Each block shown in FIG. 9 represents one or more processes, methods or subroutines, carried out in the example method 900. Furthermore, the illustrated order of blocks is illustrative only and the order of the blocks can change according to the present disclosure. Additional blocks may be added or fewer blocks may be utilized, without departing from this disclosure. The example method 900 can begin at block 901.

In block 901, the robotic arm assembly can receive input signals from a controller configured to control the robotic arm assembly 100. As a user operates the controller, signals sent by a controller to a robotic arm 150 can allow the robotic arm 150 to actuate. In at least one embodiment, the signals are received by a microprocessor and the microprocessor sends an corresponding signal a motor configured to actuate the robotic arm assembly.

In block 902, the robotic arm assembly can move in response to the controls sent by the controller. The robotic arm assembly 100 can actuate the robotic arm 150 based on the user inputted controls. For example, if the user uses a joystick to direct the robotic arm assembly 100 to extend, the robotic arm assembly can extend the arm 150.

In block 903, the interference detection system can detect for impediments in the path of the robotic arm assembly. If the interference detection system detects an impediment, the method can proceed to block 904. If the interference detection system does not detect an impediment, the method can return to block 901.

In block 904, the interference detection system halts all movement of the robotic arm assembly 100. For example, if a manipulator 160 is opening, the interference detections system can stop the actuation of the manipulator 160.

In block 905, when an impediment is detected the robotic arm assembly can ignore control signals received from the controller. In at least one example, the interference detection system can detect an impediment and the microprocessor can ignore input signals received from the controller.

The embodiments shown and described above are only examples. Many details are often found in the art such as the other features of a turbine driven shafts. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A wheelchair comprising:
a wheelchair;
a robotic arm system detachably coupled to the chair and having a base, an arm assembly, a manipulator and at least one power source;
the arm assembly including a lower arm and a upper arm;
the lower arm rotatably coupled to the base at a first end and rotatably coupled to the upper arm an opposing end,
the upper arm rotatably coupled to the manipulator at an end opposite the lower arm;
the base having at least one motor configured to rotate arm assembly; and
the manipulator having at least one electric motor configured to actuate the manipulator.

2. The wheelchair of claim 1, wherein the robotic arm system further includes an interference detection system configured to detect objects proximal to the robotic arm system and capable of disengaging any number or combination of the electric motors coupled robotic arm system thereby halting actuation of the robotic arm system.

3. The wheelchair of claim 2, wherein the interference detection system includes conductive coatings on the robotic arm system wired to a sensor hardware system configured to detect changes in capacitance as the robotic arm actuates and approaches proximal objects, the interference detection system configured to halt actuation of the robotic arm if a collision is detected.

4. The wheelchair of claim 2, wherein the robotic arm system is configured to be decoupled from the wheelchair without the use of tools.

5. The wheelchair of claim 2, wherein the manipulator is configured to rotate around a longitudinal axis of the upper arm.

6. The wheelchair of claim 2, wherein the interference detection system is a mechanical switch coupled to the robotic arm system.

7. The wheelchair of claim 2, wherein the interference detection system is an optical beam system coupled to the robotic arm, the optical beam system comprising a network of lenses channeling the optical beam to cover the surface of the robotic arm assembly.

8. The wheelchair of claim 2, wherein the interference detection system is a linear pin system.

9. The wheelchair of claim 2, wherein the at least one power source is a rechargeable battery disposed within the base, the rechargeable battery having a charging port configured to receive an electrical connect capable of recharging the battery.

10. The wheelchair of claim 2, wherein the robotic arm system further includes an emergency shut off switch configured to prevent all actuation of the robotic arm system.

11. A robotic arm system comprising:
a robotic arm system configured to detachably couple to a structure;
the robotic arm system having a base, an arm assembly, at least one power source and a manipulator;
the arm having a lower arm and a upper arm;
the lower arm rotatably coupled to the base at a first end and rotatably coupled to the upper arm at an opposing end;
the upper arm coupled to the manipulator an end opposite the lower arm;
the base including at least one electric motor configured to rotate the lower arm in relation to the base;
the lower arm further including at least one electric motor configured to rotate the upper arm in relation to the lower arm; and
the manipulator including at least one electric motor configured to actuate the manipulator.

12. The wheelchair of claim 10, wherein the robotic arm system further includes an interference detection system configured to detect objects proximal to the robotic arm system and capable of disengaging any number or combination of the electric motors coupled robotic arm system.

13. The wheelchair of claim 11, wherein the interference detection system includes conductive coatings on the robotic arm system wired to a sensor hardware system configured to detect changes in capacitance as the robotic arm actuates and approaches proximal objects, the interference detection system configured to halt actuation of the robotic arm if a collision is detect.

14. The wheelchair of claim 11, wherein the manipulator is configured to rotate around a longitudinal axis of the upper arm.

15. The robotic arm system of claim 11, wherein the interference detection system is a mechanical switch coupled to the robotic arm system.

16. The robotic arm system of claim 11, wherein the interference detection system is an optical beam system coupled to the robotic arm, the optical beam system comprising a network of lenses channeling the beam to cover the surface of the robotic arm assembly.

17. The wheelchair of claim 11, wherein the at least one power source is a rechargeable battery disposed within the base, the rechargeable battery having a charging port configured to receive an electrical connect capable of recharging the battery.

18. The wheelchair of claim 11, wherein the robotic arm system further includes an emergency shut off switch configured to prevent all actuation of the robotic arm system.

19. A method detecting inference of a robotic arm system, the method comprising:
receiving input from a controller to actuate a robotic arm system;
actuating the robotic arm system in response to the input from the controller;
detecting interference as the robotic arm assembly actuates in response to the input;
halting actuation if interference is detected; and
disregarding input if interference is detected.

20. The method of claim 19, wherein the robotic arm assembly retracts away from detected interference.
